(19) United States
(12) Patent Application Publication
(10) Pub. No.: US 2026/0179935 A1
(43) Pub. Date: Jun. 25, 2026

(54) ELECTROLYTE FOR RECHARGEABLE LITHIUM BATTERY AND RECHARGEABLE LITHIUM BATTERY INCLUDING THE SAME

(71) Applicant: Samsung SDI Co., Ltd., Yongin-si, Gyeonggi-do (KR)

(72) Inventors: Seunghyeon SON, Yongin-si (KR); Arum YU, Yongin-si (KR); Sanghoon KIM, Yongin-si (KR); Tae Hyon BAE, Yongin-si (KR); Harim LEE, Yongin-si (KR); Sanghyung KIM, Yongin-si (KR); Youngkyeong SHIN, Yongin-si (KR)

(21) Appl. No.: 18/838,200

(22) PCT Filed: Mar. 12, 2024
(86) PCT No.: PCT/KR2024/003122

§ 371 Date: Aug. 13, 2024

(30) Foreign Application Priority Data
Sep. 21, 2023 (KR) 10-2023-0126529

(51) Int. Cl. H01M 4/525; H01M 4/485; H01M 10/0567; H01M 10/0569

(52) U.S. Cl. CPC H01M 4/525; H01M 4/485; H01M 10/0567; H01M 10/0569

(57) ABSTRACT

Disclosed are an electrolyte for a rechargeable lithium battery and a rechargeable lithium battery including the same, the electrolyte including a lithium salt; a non-aqueous organic solvent including a solvent represented by Chemical Formula 1; and an additive represented by Chemical Formula 2:

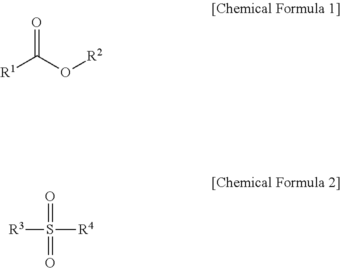

(The description of each chemical formula follows the specification.)

### TECHNICAL FIELD

An electrolyte for a rechargeable lithium battery and a rechargeable lithium battery including the same are disclosed.

### BACKGROUND ART

Recently, with the rapid spread of electronic devices that use batteries, such as mobile phones, laptop computers, and electric vehicles, the demand for rechargeable batteries with high energy density and high capacity is rapidly increasing. Accordingly, research and development to improve the performance of rechargeable lithium batteries is actively underway.

A rechargeable lithium battery includes a positive electrode and a negative electrode including an active material capable of intercalating and deintercalating lithium ions, and an electrolyte, and electrical energy is produced through oxidation and reduction reactions when lithium ions are intercalated/deintercalated from the positive electrode and negative electrode.

However, as the rechargeable lithium battery is repeatedly charged and discharged, lithium dendrites are generated on the surface of the negative electrode, which reduces cycle-life and/or increases resistance, and may cause internal short circuits. This phenomenon becomes more severe as the charging voltage of the rechargeable lithium battery increases and/or the mixture density of the negative electrode increases.

### DISCLOSURE

### Technical Problem

An embodiment provides an electrolyte for a rechargeable lithium battery that improves cycle-life of the rechargeable lithium battery and suppresses an increase in resistance even when a charging voltage of the rechargeable lithium battery is increased and/or a mixture density of the negative electrode is increased.

Another embodiment provides a rechargeable lithium battery containing the electrolyte for a rechargeable lithium battery.

### Technical Solution

An embodiment provides an electrolyte for a rechargeable lithium battery including a lithium salt; a non-aqueous organic solvent including a solvent represented by Chemical Formula 1; and an additive represented by Chemical Formula 2:

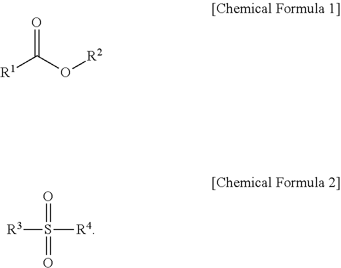

Another embodiment provides a rechargeable lithium battery including a positive electrode including a positive electrode active material; a negative electrode including a negative electrode active material; and the electrolyte.

### Advantageous Effects

The electrolyte for a rechargeable lithium battery according to an embodiment can suppress an increase in resistance while improving the cycle-life of the rechargeable lithium battery, even if the charging voltage of the rechargeable lithium battery is increased and/or the mixture density of the negative electrode is increased.

### DESCRIPTION OF THE DRAWINGS

FIGS. 1 to 4 are schematic views showing rechargeable lithium batteries according to embodiments.

### BEST MODE

Hereinafter, embodiments of the present invention will be described in detail. However, these embodiments are exemplary, the present invention is not limited thereto and the present invention is defined by the scope of claims.

As used herein, when specific definition is not otherwise provided, it will be understood that when an element such as a layer, film, region, or substrate is referred to as being “on” another element, it can be directly on the other element or intervening elements may also be present.

As used herein, when specific definition is not otherwise provided, the singular may also include the plural. In addition, unless otherwise specified, “A or B” may mean “including A, including B, or including A and B.”

As used herein, “combination thereof” may mean a mixture, a stack, a composite, a copolymer, an alloy, a blend, and a reaction product of constituents.

As used herein, when a definition is not otherwise provided, ‘substituted’ refers to replacement of hydrogen of a compound by a substituent selected from a halogen atom (F, Cl, Br, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and a combination thereof.

As used herein, when a definition is not otherwise provided, in chemical formula, hydrogen is bonded at the position when a chemical bond is not drawn where supposed to be given.

As used herein, the “mixture density of the negative electrode” is a value calculated by dividing a weight of the components (active material, conductive material, binder, etc.) excluding the current collector in the negative electrode by a volume thereof.

### (Electrolyte)

An embodiment provides an electrolyte for a rechargeable lithium battery including a lithium salt; a non-aqueous organic solvent including a solvent represented by Chemical Formula 1; and an additive represented by Chemical Formula 2:

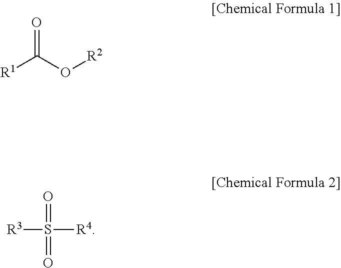

In Chemical Formula 1, R¹ has 3 or more carbon atoms, and oxidation resistance is high when compared to the case where R¹ has 2 or less carbon atoms. Accordingly, the solvent represented by Chemical Formula 1 is suitable for use in a high voltage environment of greater than or equal to 4.5 V.

Meanwhile, in Chemical Formula 2, R³ and R⁴ are each independently an aryl group, and R³ and R⁴ are each independently an alkyl group or alkenyl group, which is advantageous in suppressing the formation and growth of lithium dendrites. Accordingly, the additive represented by Chemical Formula 2 can suppress the formation and growth of lithium dendrites and allow lithium ions to enter the negative electrode evenly, even if the mixture density of the negative electrode is increased.

Therefore, the electrolyte of an embodiment including both the solvent represented by Chemical Formula 1 and the additive represented by Chemical Formula 2 can suppress increase in resistance while improving cycle-life of the rechargeable lithium battery even if the charging voltage of the rechargeable lithium battery is increased and/or the mixture density of the negative electrode is increased.

Hereinafter, an electrolyte for a rechargeable lithium battery according to one embodiment will be described in more detail.

### Non-aqueous Organic Solvent

The non-aqueous organic solvent serves as a medium for transmitting ions taking part in the electrochemical reaction of a battery.

As described above, the electrolyte for a rechargeable lithium battery according to an embodiment includes a solvent represented by Chemical Formula 1. In Chemical Formula 1, R¹ may be a substituted or unsubstituted alkyl group having 3 to 10 carbon atoms. For example, R¹ may be a propyl group.

In Chemical Formula 1, R² may be a substituted or unsubstituted C1 to C10 alkyl group. For example, R² may be an ethyl group.

Representative examples of the solvent represented by Chemical Formula 1 are as follows:

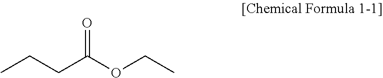

The solvent represented by Chemical Formula 1 may be included in an amount of greater than or equal to 70 volume %, or greater than or equal to 75 volume %, based on a total volume of the non-aqueous organic solvent. The upper limit is not specifically limited, but may be less than or equal to 85 volume %, or less than or equal to 80 volume %. Within this range, an electrolyte including the solvent represented by Chemical Formula 1 may exhibit high oxidation resistance.

The non-aqueous organic solvent may further include a carbonate-based solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate. (EC), propylene carbonate (PC), butylene carbonate (BC), and the like.

The carbonate-based solvent can be used alone or in combination of two or more types.

For example, among the carbonate-based solvents, ethylene carbonate (EC) and propylene carbonate (PC), which are cyclic carbonates, can be mixed and used. A mixture of ethylene carbonate (EC) and propylene carbonate (PC) has a high dielectric constant, dissociates lithium salt to generate lithium ions, and has the effect of moving the lithium ions. However, the mixture of ethylene carbonate (EC) and propylene carbonate (PC) has a very high viscosity, and thus, when applied in excessive amounts, the performance of the rechargeable lithium battery may deteriorate.

In this case, based on a total volume of the non-aqueous organic solvent, the solvent represented by Chemical Formula 1 may be included in an amount of 70 to 85 volume %, or 75 to 80 volume %; the ethylene carbonate (EC) may be included in an amount of 1 to 15 volume %, or 5 to 10 volume %; and the propylene carbonate (PC) may be included in an amount of 5 to 20 volume %, or 15 to 20 volume %. Within this range, the effect of the solvent represented by Chemical Formula 1; and the effects of a mixture of ethylene carbonate (EC) and propylene carbonate (PC) can be harmonized.

### Additive

As described above, the electrolyte for a rechargeable lithium battery according to an embodiment includes an additive represented by Chemical Formula 2.

In Chemical Formula 2, R³ and R⁴ may each independently be a substituted or unsubstituted aryl group having 3 to 20 carbon atoms. For example, at least one of R³ and R⁴ may be a phenyl group.

Representative examples of the additive represented by Chemical Formula 2 are as follows:

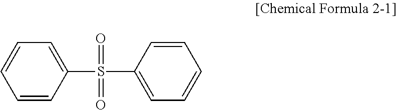 [SMILES: O=S(=O)(c1ccccc1)c1ccccc1]

The additive may be included in an amount of 0.1 to 10 wt %, 0.5 to 7 wt %, or 1 to 5 wt %, based on a total amount of the electrolyte. Within this range, an electrolyte including the additive represented by Chemical Formula 2 can effectively inhibit the formation and growth of lithium dendrites.

### Lithium Salt

The lithium salt dissolved in the organic solvent supplies lithium ions in a battery, enables a basic operation of a rechargeable lithium battery, and improves transportation of the lithium ions between positive and negative electrodes.

The lithium salt may be LiPF₆.

A concentration of the lithium salt may be 0.1 M to 2.0 M.

### (Rechargeable Lithium Battery)

Another embodiment provides a rechargeable lithium battery including a positive electrode including a positive electrode active material; a negative electrode including a negative electrode active material; and the electrolyte.

Because the rechargeable lithium battery according to an embodiment includes the electrolyte of the aforementioned embodiment, the increase in resistance can be suppressed while the cycle-life is improved, even if the charging voltage of the battery is increased and/or the mixture density of the negative electrode is increased.

Hereinafter, descriptions that overlap with the above will be omitted, and a rechargeable lithium battery according to an embodiment will be described in more detail.

### Upper Charge Limit Voltage

As the rechargeable lithium battery according to an embodiment includes the electrolyte of the aforementioned embodiment, the cycle-life can be improved and an increase in resistance can be suppressed even at high voltage.

Specifically, the rechargeable lithium battery may have an upper charge limit voltage of greater than or equal to 4.5 V.

### Positive Electrode Active Material

The positive electrode active material may be a compound (lithiated intercalation compound) capable of intercalating and deintercalating lithium. Specifically, one or more types of composite oxides of lithium and a metal selected from cobalt, manganese, nickel, and combinations thereof may be used.

The composite oxide may be a lithium transition metal composite oxide, and specific examples may include lithium nickel-based oxide, lithium cobalt-based oxide, lithium manganese-based oxide, a lithium iron phosphate-based compound, cobalt-free nickel-manganese-based oxide, or a combination thereof.

As an example, a compound represented by any of the following chemical formulas may be used. LiₐA_{1-b}XbO_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, ≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5a); Li_{(3-f)}Fe₂(PO₄)₃ (0≤f≤2); LiₐFePO₄ (0.90≤a≤1.8).

In the above chemical formulas, A is Ni, Co, Mn, or a combination thereof; X is Al, Ni, Co, Mn, Cr, Fe, Mg, Sr, V, a rare earth element, or a combination thereof; D is 0, F, S, P, or a combination thereof; G is Al, Cr, Mn, Fe, Mg, La, Ce, Sr, V, or a combination thereof; and L¹ is Mn, Al, or a combination thereof.

As an example, the positive electrode active material may have a nickel content of greater than or equal to 80 mol %, greater than or equal to 85 mol %, greater than or equal to 90 mol %, greater than or equal to 91 mol %, or greater than or equal to 94 mol % based on 100 mol % of metals excluding lithium in the lithium transition metal composite oxide. and may be a high nickel-based positive electrode active material of less than or equal to 99 mol %. The high-nickel-based positive electrode active materials can achieve high capacity and can be applied to high-capacity, high-density rechargeable lithium batteries.

The positive electrode active material may be, for example, lithium nickel-based oxide represented by Chemical Formula 11, lithium cobalt-based oxide represented by Chemical Formula 12, a lithium iron phosphate-based compound represented by Chemical Formula 13, and cobalt-free lithium nickel manganese-based oxide represented by Chemical Formula 14, or a combination thereof.

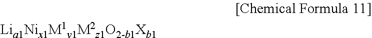

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² are each independently one or more elements selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 1, 0.6≤x1≤1, 0≤y1≤0.4, and 0≤z1≤0.4, or 0.8≤x1≤1, 0≤y1≤0.2, and 0≤z1≤0.2.

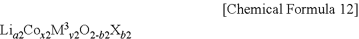

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

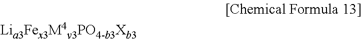

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn, and Zr, and X is one or more elements selected from F, P, and S.

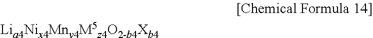

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

In particular, the electrolyte of the above-described embodiment can significantly improve high-voltage characteristics of a battery using the lithium cobalt-based oxide represented by Chemical Formula 12.

### Positive Electrode

The positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive that can function as a sacrificial positive electrode.

A content of the positive electrode active material may be 90 wt % to 99.5 wt %, and a content of the binder and the conductive material may be 0.5 wt % to 5 wt %, respectively based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

The current collector may be Al, but is not limited thereto.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon-based negative electrode active material, for example, crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to some embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Negative Electrode

The mixture density of the negative electrode may be greater than or equal to 1.7 g/cc. Even if the mixture density of the negative electrode is increased in this way, the electrolyte of an embodiment can suppress the increase in resistance while improving cycle-life of the rechargeable lithium battery.

The negative electrode for a rechargeable lithium battery includes a current collector and a negative electrode active material layer on the current collector. The negative electrode active material layer includes a negative electrode active material and may further include a binder and/or a conductive material.

For example, the negative electrode active material layer may include 90 wt % to 99 wt % of the negative electrode active material, 0.5 wt % to 5 wt % of the binder, and 0.5 wt % to 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, it may further include a cellulose-based compound capable of imparting viscosity. The cellulose-based compound includes one or more of carboxylmethyl cellulose, hydroxypropylmethyl cellulose, methyl cellulose, or alkali metal salts thereof. The alkali metal may be Na, K, or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, or a combination thereof.

The conductive material is included to provide electrode conductivity, and any electrically conductive material may be used as a conductive material unless it causes a chemical change. Specific examples of the conductive material may be a carbon-based material such as natural graphite, artificial graphite, carbon black, acetylene black, ketjen black, a carbon fiber, a carbon nanofiber, a carbon nanotube, and the like; a metal-based material such as copper, nickel, aluminum silver, and the like in a form of a metal powder or a metal fiber; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof, but is not limited thereto.

### Separator

Depending on the type of the rechargeable lithium battery, a separator may be present between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### Rechargeable Lithium Battery

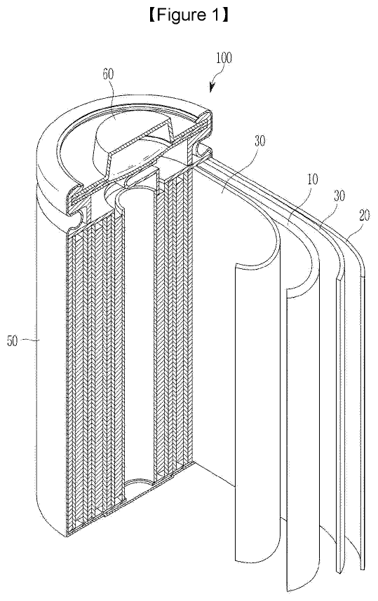

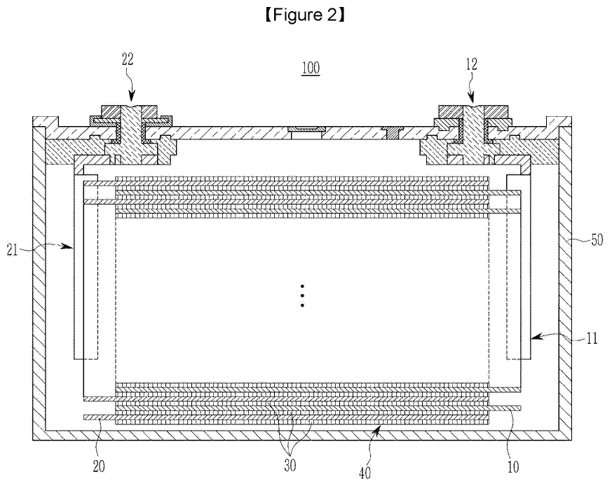

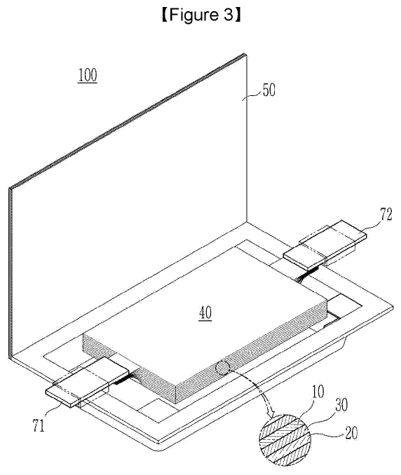

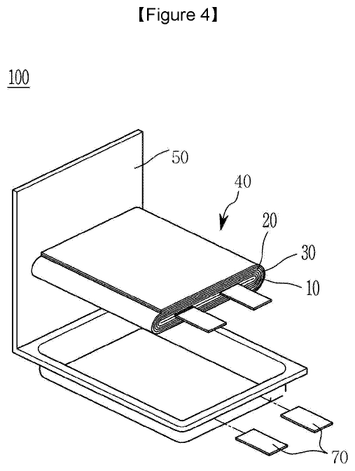

The rechargeable lithium battery may be classified into cylindrical, prismatic, pouch, or coin-type batteries, and the like depending on their shape. FIGS. 1 to 4 are schematic views illustrating rechargeable lithium batteries according to embodiments. FIG. 1 shows a cylindrical battery, FIG. 2 shows a prismatic battery, and FIGS. 3 and 4 show pouch-type batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte (not shown). The rechargeable lithium battery 100 may include a sealing member 60 sealing the case 50, as shown in FIG. 1. In FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 may include an electrode tab 70, which may be, for example, a positive electrode tab 71 and a negative electrode tab 72 serving as an electrical path for inducing the current formed in the electrode assembly 40 to the outside.

The rechargeable lithium battery according to an embodiment may be applied to automobiles, mobile phones, and/or various types of electrical devices, but the present invention is not limited thereto.

### MODE FOR INVENTION

Hereinafter, examples of the present invention and comparative examples are described. These examples, however, are not in any sense to be interpreted as limiting the scope of the invention.

### EXAMPLES AND COMPARATIVE EXAMPLES

Electrolytes and rechargeable lithium battery cells were manufactured as follows.

### Example 1

### (1) Preparation of Electrolyte

An electrolyte was prepared by dissolving 1.3 M of LiPF₆ in a non-aqueous organic solvent prepared by mixing ethylene carbonate (EC), propylene carbonate (PC), and a solvent represented by Chemical Formula 1 (EB) in a 10:15:75 and then, adding 1 wt % of an additive represented by Chemical Formula 2 (DPS) thereto:

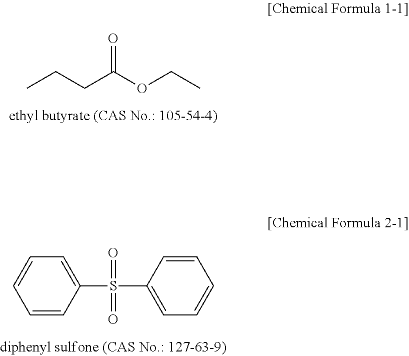

### (2) Manufacturing of Rechargeable Lithium Battery Cells

LiCoO₂ as a positive electrode active material, polyvinylidene fluoride as a binder, and acetylene black as a conductive material were mixed respectively in a weight ratio of 96:3:1, and then, dispersed in N-methyl pyrrolidone to prepare positive electrode active material slurry.

The positive electrode active material slurry was coated on a 15 μm-thick Al foil, dried at 100° C., and pressed to manufacture a positive electrode.

Artificial graphite as a negative electrode active material, a styrene-butadiene rubber binder, and carboxylmethyl cellulose were mixed and dispersed in a weight ratio of 98:1:1 in distilled water to prepare negative electrode active material slurry.

The negative electrode active material slurry was coated on a 10 μm-thick Cu foil, dried at 100° C., and pressed to manufacture a negative electrode. At this time, a mixture density of the negative electrode was set to 1.7 g/cc. For reference, the mixture density of the negative electrode was calculated by dividing a weight of a negative electrode active material layer by its volume after removing the Cu foil (current collector) from the negative electrode.

The positive and negative electrodes and a polyethylene separator having a thickness of 10 μm were assembled to manufacture an electrode assembly, and the electrolyte was injected to prepare a rechargeable lithium battery cell.

### Example 2

An electrolyte and a rechargeable lithium battery cell were manufactured in the same manner as in Example 1 except that the electrolyte was prepared by adding 3 wt % of the additive.

### Example 3

An electrolyte and a rechargeable lithium battery cell were manufactured in the same manner as in Example 1 except that the electrolyte was prepared by adding 5 wt % of the additive.

### Example 4

An electrolyte and a rechargeable lithium battery cell were manufactured in the same manner as in Example 2 except that a non-aqueous organic solvent prepared by mixing ethylene carbonate (EC), propylene carbonate (PC), and the solvent represented by Chemical Formula 1 (EB) in a ratio of 10:20:70 was used to prepare the electrolyte.

### Example 5

An electrolyte and a rechargeable lithium battery cell were manufactured in the same manner as in Example 2 except that a non-aqueous organic solvent prepared by mixing ethylene carbonate (EC), propylene carbonate (PC), and the solvent represented by Chemical Formula 1 (EB) in a ratio of 10:10:80 was used to prepare the electrolyte.

### Comparative Example 1

An electrolyte was prepared by dissolving 1.3 M of LiPF₆ in a non-aqueous organic solvent prepared by mixing ethylene carbonate (EC), propylene carbonate (PC), and a solvent represented by Chemical Formula A (PP) in a weight ratio of 10:15:75:

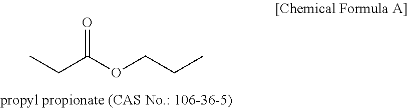

Except for using the above electrolyte, an electrolyte and a rechargeable lithium battery cell were manufactured in the same manner as in Example 1.

### Comparative Example 2

An electrolyte was prepared by dissolving 1.3 M of LiPF₆ in a non-aqueous organic solvent prepared by mixing ethylene carbonate (EC), propylene carbonate (PC), and the solvent represented by Chemical Formula 1 (EB) in a weight ratio of 10:15:30:45.

Except for using the above electrolyte, an electrolyte and a rechargeable lithium battery cell were manufactured in the same manner as in Example 1.

### Comparative Example 3

An electrolyte was prepared by dissolving 1.3 M of LiPF₆ in a non-aqueous organic solvent prepared by mixing ethylene carbonate (EC), propylene carbonate (PC), and the solvent represented by Chemical Formula A (PP) in a weight ratio of 10:15:45:30.

Except for using the above electrolyte, an electrolyte and a rechargeable lithium battery cell were manufactured in the same manner as in Example 1.

### Comparative Example 4

An electrolyte was prepared by dissolving 1.3 M of LiPF₆ in a non-aqueous organic solvent prepared by mixing ethylene carbonate (EC), propylene carbonate (PC), and the solvent represented by Chemical Formula 1 (EB) in a weight ratio of 10:15:75.

Except for using the above electrolyte, an electrolyte and a rechargeable lithium battery cell were manufactured in the same manner as in Example 1 except that the above electrolyte.

### Comparative Example 5

An electrolyte and a rechargeable lithium battery cell were manufactured in the same manner as in Example 1 except that the solvent represented by Chemical Formula A (PP) was used instead of the solvent represented by Chemical Formula 1 (EB) to prepare the electrolyte.

### Comparative Example 6

An electrolyte and a rechargeable lithium battery cell were manufactured in the same manner as in Example 2 except that the solvent represented by Chemical Formula A (PP) was used instead of the solvent represented by Chemical Formula 1 (EB) to prepare the electrolyte.

### Comparative Example 7

An electrolyte and a rechargeable lithium battery cell were manufactured in the same manner as in Example 3 except that the solvent represented by Chemical Formula A (PP) was used instead of the solvent represented by Chemical Formula 1 (EB) to prepare the electrolyte.

### Comparative Example 8

An electrolyte and a rechargeable lithium battery cell were manufactured in the same manner as in Example 1 except that a solvent represented by Chemical Formula B (MP) was used instead of the solvent represented by Chemical Formula 1 (EB) to prepare the electrolyte:

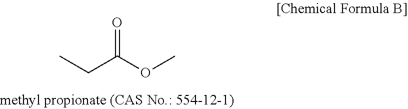

### Comparative Example 9

An electrolyte and a rechargeable lithium battery cell were manufactured in the same manner as in Example 1 except that a solvent represented by Chemical Formula C (EP) was used instead of the solvent represented by Chemical Formula 1 (EB) to prepare the electrolyte:

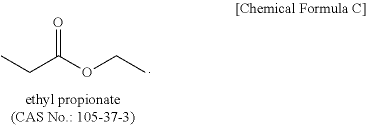

### Comparative Example 10

An electrolyte and a rechargeable lithium battery cell were manufactured in the same manner as in Example 1 except that an additive represented by Chemical Formula D (DMS) was used instead of the additive represented by Chemical Formula 2 to prepare the electrolyte:

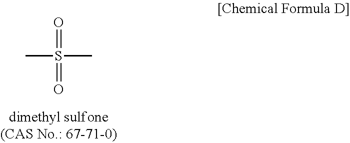

The electrolytes according to Examples 1 to 5 and Comparative Examples 1 to 10 are respectively summarized in Table 1.

TABLE 1

| | Solvent (volume %) | | | | | | Additive (wt %) | |
|---|---|---|---|---|---|---|---|---|
| | EC | PC | EB | PP | MP | EP | DPS | DMS |
| Comp. Ex. 1 | 10 | 15 | — | 75 | — | — | — | — |
| Comp. Ex. 2 | 10 | 15 | 30 | 45 | — | — | — | — |
| Comp. Ex. 3 | 10 | 15 | 45 | 30 | — | — | — | — |
| Comp. Ex. 4 | 10 | 15 | 75 | | — | — | — | — |
| Comp. Ex. 5 | 10 | 15 | — | 75 | — | — | 1 | — |
| Comp. Ex. 6 | 10 | 15 | — | 75 | — | — | 3 | — |
| Comp. Ex. 7 | 10 | 15 | — | 75 | — | — | 5 | — |
| Comp. Ex. 8 | 10 | 15 | — | — | 75 | — | 1 | — |
| Comp. Ex. 9 | 10 | 15 | — | — | — | 75 | 1 | — |
| Comp. Ex. 10 | 10 | 15 | 75 | — | — | — | — | 1 |
| Ex. 1 | 10 | 15 | 75 | — | — | — | 1 | — |
| Ex. 2 | 10 | 15 | 75 | — | — | — | 3 | — |
| Ex. 3 | 10 | 15 | 75 | — | — | — | 5 | — |
| Ex. 4 | 10 | 20 | 70 | — | — | — | 3 | — |
| Ex. 5 | 10 | 10 | 80 | — | — | — | 3 | — |

In Table 1, an amount of the solvent represents a volume % of each solvent in the volume (100 volume %) of the non-aqueous organic solvent, and an amount of the additive represents a weight percent of the additive of the total weight (100 wt %) of the electrolyte including the non-aqueous organic solvent+lithium salt+additive.

### EVALUATION EXAMPLES

The rechargeable lithium battery cells were evaluated in the following manner.

### Evaluation 1: Evaluation of Room-temperature Charge/discharge Cycle Characteristics

The cycle characteristics of the rechargeable lithium battery cells according to Examples 1 to 5 and Comparative Examples 1 to 10 were evaluated after charging and discharging under the following conditions, and the results are shown in Table 2.

After 200 cycles of charge and discharge under 0.33 C charge (CC/CV, 4.53 V, 0.025 C Cut-off)/1.0 C discharge (CC, 2.5V Cut-off) conditions at 25° C., capacity retention and a direct current internal resistance (DC-IR) changes of the cells were measured.

A capacity retention rate was calculated according to Equation 1, and a DC internal resistance change rate was calculated by using ΔV/ΔI (voltage change/current change) according to Equation 2.

$$Capacity retention rate = ( discharge capacity after 200 cycles / \\ discharge capacity after 1 cycle ) * 100 \qquad [ Equation 1 ]$$

$$DC internal resistance change rate = [ ( DC - IR after 200 cycles ) - ( DC - IR after 1 cycle ) ] / ( DC - IR after 1 cycle ) * 100 \qquad [ Equation 2 ]$$

TABLE 2

| | Capacity retention rate | DC-IR change rate after 200 |
|---|---|---|
| | (@25° C., 200 cycle) | cycles @25° C. (%) |
| Comp. Ex. 1 | 67 | 38 |
| Comp. Ex. 2 | 69 | 35 |
| Comp. Ex. 3 | 75 | 32 |
| Comp. Ex. 4 | 78 | 31 |
| Comp. Ex. 5 | 79 | 28 |
| Comp. Ex. 6 | 82 | 25 |
| Comp. Ex. 7 | 80 | 26 |
| Comp. Ex. 8 | 47 | 58 |
| Comp. Ex. 9 | 58 | 49 |
| Comp. Ex. 10 | 71 | 41 |
| Ex. 1 | 87 | 22 |
| Ex. 2 | 90 | 19 |
| Ex. 3 | 88 | 21 |
| Ex. 4 | 85 | 24 |
| Ex. 5 | 86 | 23 |

Each of the electrolytes according to Examples 1 to 5 and Comparative Examples 1 to 10 was evaluated at a high voltage (4.53 V) and a high negative electrode mixture density (1.7 g/cc). Referring to Table 2, as in an example embodiment, when the electrolytes simultaneously including the solvent represented by Chemical Formula 1 and the additive represented by Chemical Formula 2 were used, compared with the comparative examples, it was confirmed that cycle-life of the rechargeable lithium battery cells were not only significantly improved, but also an increased in resistance was effectively suppressed.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

[Description of Symbols]

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

1. An electrolyte for a rechargeable lithium battery, comprising
a lithium salt;
a non-aqueous organic solvent including a solvent represented by Chemical Formula 1; and
an additive represented by Chemical Formula 2: 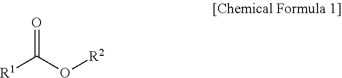
wherein, in Chemical Formula 1,
R¹ is a substituted or unsubstituted alkyl group having 3 to 10 carbon atoms; and
R² is a substituted or unsubstituted C1 to C10 alkyl group; 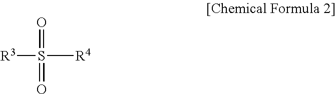
wherein, in Chemical Formula 2,
R³ and R⁴ are each independently a substituted or unsubstituted aryl group having 3 to 20 carbon atoms.

2. The electrolyte for a rechargeable lithium battery as claimed in claim 1, wherein
R¹ is a propyl group.

3. The electrolyte for a rechargeable lithium battery as claimed in claim 1, wherein
R² is an ethyl group.

4. The electrolyte for a rechargeable lithium battery as claimed in claim 1, wherein
Chemical Formula 1 is represented by Chemical Formula 1-1:

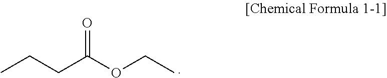

5. The electrolyte for a rechargeable lithium battery as claimed in claim 1, wherein
the solvent represented by Chemical Formula 1 is included in an amount of greater than or equal to 70 volume %, based on a total volume of the non-aqueous organic solvent.

6. The electrolyte for a rechargeable lithium battery as claimed in claim 1, wherein
the non-aqueous organic solvent further includes a carbonate-based solvent.

7. The electrolyte for a rechargeable lithium battery as claimed in claim 6, wherein
the carbonate-based solvent includes ethylene carbonate (EC) and propylene carbonate (PC).

8. The electrolyte for a rechargeable lithium battery as claimed in claim 7, wherein
based on a total volume of the non-aqueous organic solvent, the solvent represented by Chemical Formula 1 is included in an amount of 70 to 85 volume %, the ethylene carbonate (EC) is included in an amount of 1 to 15 volume %, and the propylene carbonate (PC) is included in an amount of 5 to 20 volume %.

9. The electrolyte for a rechargeable lithium battery as claimed in claim 1, wherein
at least one of R³ and R⁴ is a phenyl group.

10. The electrolyte for a rechargeable lithium battery as claimed in claim 1, wherein
Chemical Formula 2 is represented by Chemical Formula 2-1:

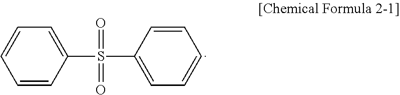 [SMILES: O=S(=O)(c1ccccc1)c1ccccc1]

11. The electrolyte for a rechargeable lithium battery as claimed in claim 1, wherein
the additive is included in an amount of 0.1 to 10 wt % based on a total amount of the electrolyte.

12. The electrolyte for a rechargeable lithium battery as claimed in claim 1, wherein
the lithium salt is LiPF₆.

13. The electrolyte for a rechargeable lithium battery as claimed in claim 1, wherein
a concentration of the lithium salt is 0.1 M to 2.0 M.

14. A rechargeable lithium battery, comprising
a positive electrode including a positive electrode active material;
a negative electrode including a negative electrode active material; and
the electrolyte according to claim 1.

15. The rechargeable lithium battery as claimed in claim 14, wherein
a mixture density of the negative electrode is greater than or equal to 1.7 g/cc.

16. The rechargeable lithium battery as claimed in claim 14, wherein
the positive electrode active material includes lithium nickel-based oxide, lithium cobalt-based oxide, lithium manganese-based oxide, a lithium iron phosphate-based compound, cobalt-free nickel-manganese-based oxide, or a combination thereof.

17. The rechargeable lithium battery as claimed in claim 14, wherein
the negative electrode active material includes a carbon-based negative electrode active material, a Si-based negative electrode active material, a combination thereof.

18. The rechargeable lithium battery as claimed in claim 14, wherein
the rechargeable lithium battery has an upper charge limit voltage of greater than or equal to 4.5 V.
